(19) United States
(12) Patent Application Publication
(10) Pub. No.: US 2020/0410594 A1
(43) Pub. Date: Dec. 31, 2020

(54) INTELLIGENT PLANNING FOR TOTAL COST OF OWNERSHIP OBLIGATIONS

(71) Applicant: Wells Fargo Bank, N.A., San Francisco, CA (US)

(72) Inventors: August William Larson, III, St. Louis, MO (US); Donna E. Peterson, Seagrove, NC (US); Christopher C. Maurer, Charlotte, NC (US); Alexandra Rapp, Indian Trail, NC (US); Scarlette A. Rose, Charlotte, NC (US); Dinah Villar, Charlotte, NC (US); Barbara Ellen Metkowski, Charlotte, NC (US); Michael Smid, Advance, NC (US)

(21) Appl. No.: 15/159,555

(22) Filed: May 19, 2016

(51) Int. Cl. G06Q 40/06; H04L 29/08; G06Q 30/02

(52) U.S. Cl. CPC G06Q 40/06; G06Q 30/0283; H04L 67/306

(57) ABSTRACT

A system and computer-implemented method for use in generating an investment strategy for retirement income growth utilizing a total cost of ownership (TCO) obligation for an item as an input is provided. Information about the user may be gathered. An item having a TCO obligation may be determined using the user information. The TCO obligation for the item may be estimated from a plurality of sources. A category for the item may be determined. An impact on the user's retirement income growth based on the TCO obligation for the item may be assessed. A modification to the investment strategy, the item, and/or a lifestyle interest of the user may be recommended based on the assessed retirement income growth impact and/or the category of the item. Steps to implement the recommendation may then be provided to the user.

### TECHNICAL FIELD

The present application generally relates to a system and computer-implemented method for use as a tool in retirement income planning, and more particularly, to a system and computer-implemented method for use in generation of an investment plan or strategy for retirement income growth and stabilization utilizing a total cost of ownership obligation for an item.

### BACKGROUND

The financial services industry has access to computer software tools that are used by financial advisors, for example, to investigate the question of whether or not an individual has sufficient income for retirement. A financial advisor may provide investment strategies related to retirement income growth based on information received from the client and/or the experiences of the financial advisor. Individuals and financial advisors, however, may have difficulty estimating the total cost of ownership (TCO) obligation for an item when planning an investment strategy for retirement income growth. The TCO obligation for an item may include, in addition to the purchase price for an item, additional costs, for example, energy costs for using the item, likely repair costs, related fees, unknown or unanticipated costs by the user which are typically associated with the item, and/or disposal costs, and the like, which may not be readily apparent to the individual and/or financial advisor.

Estimating an accurate TCO obligation for an item may be difficult for the user or financial advisor. The TCO obligation for an item may depend on a variety of factors, for example, the market price for the item, the location of the user, and/or the expected lifetime of the item.

Without an accurate estimate for the TCO obligation for an item, the individual and/or the financial advisors may incorrectly estimate the TCO obligation for an item. As a result, a proposed investment strategy for retirement income growth for the client may not satisfy the client's retirement goal.

Thus, there is a need for a system and computer-implemented method for use in the generation of an investment strategy for retirement income growth which estimates the TCO obligation for an item from a number of sources and utilizes the estimated TCO obligation for the item to assess an impact of the item on the user's retirement income growth.

### BRIEF SUMMARY OF THE INVENTION

The present application relates to a computer-implemented method and system for use as a tool in planning strategic growth and management of retirement income utilizing a total cost of ownership (TCO) for an item as an input. With the present application, investment strategies related to retirement income growth may be evaluated against acquiring and using an item over a period of time. As a result of the present application, the user may obtain expenditure information insight associated with a particular item and/or a goal over a period of time. Accordingly, the present application may provide the user with previously unknown expense information associated with the item and/or goal which may impact their investment strategy.

In an exemplary embodiment, the present application is related to a computer-implemented method for generating an investment strategy related to retirement income growth for a user. Information about the user may be gathered. A processor may determine an item having a total cost of ownership (TCO) obligation based on the user information. The processor may estimate the TCO obligation for the item. In estimating the TCO obligation for the item, the processor may estimate a cost associated with the item based on a plurality of data sources. The plurality of data sources may comprise at least one of internet information, manufacturer information, a consumer report, and information from social media. A data source may comprise Internet of Things (IoT) device data for a similar item. The processor may then assess an impact on the retirement income growth for the user based on the TCO obligation for the item and/or the user information. The processor may recommend a modification to the investment strategy based on the assessed impact to the retirement income growth.

In one embodiment of the method, the information about the user may comprise at least one of financial information, career information, financial risk tolerance, a lifestyle interest, a demographic value, a user age, a geographic preference, and a social media interest.

In one embodiment of the method, the TCO obligation for the item may comprise a net monetary value estimate for the item over a period of time the user maintains control over the item.

In one embodiment of the method, the item may comprise an asset, an interest, or a service. The item may comprise a consumable.

In one embodiment of the method, the item may be categorized based on the user information. The processor may then recommend a modification to an item, the investment strategy, and/or a lifestyle interest of the user based on the assessed impact to the retirement income growth and the category of the item.

In one embodiment of the method, the recommended modification to the investment strategy may be based on a probability of implementation of the modification by the user and an amount of reduction in retirement income growth shortfall caused by the TCO obligation for the item.

In another exemplary embodiment, the present application is related to a system for generating an investment strategy related to retirement income growth for a user. A processor may be configured to gather information related to the user. The processor may determine an item having a total cost of ownership (TCO) obligation based on the user information. The processor may estimate the TCO obligation for the item. In estimating the TCO obligation for the item, the processor may estimate a cost associated with the item based on a plurality of data sources. The plurality of data sources may comprise at least one of internet information, manufacturer information, a consumer report, and information from social media. A data source may comprise Internet of Things (IoT) device data for a similar item. The processor may then assess an impact on the retirement income growth for the user based on the TCO obligation for the item and/or the user information. The processor may recommend a modification to the investment strategy based on the assessed impact to the retirement income growth.

In one embodiment of the system, the information about the user may comprise at least one of financial information, career information, financial risk tolerance, a lifestyle interest, a demographic value, a user age, a geographic preference, and a social media interest.

In one embodiment of the system, the TCO obligation for the item may comprise a net monetary value estimate for the item over a period of time the user maintains control over the item. The item may comprise an asset, an interest, a consumable or a service.

In one embodiment of the system, the item may be categorized based on the user information. The processor may then recommend a modification to an item, the investment strategy, and/or the lifestyle interest of the user based on the assessed impact to the retirement income growth and the category of the item.

In one embodiment of the system, the recommended modification to the investment strategy may be based on a probability of implementation of the modification by the user and an amount of reduction in retirement income growth shortfall caused by the TCO obligation for the item.

In another exemplary embodiment, the present application is related to a system for generating an investment strategy related to retirement income growth for a user. A processor may be configured to gather information related to the user. The processor may determine an item having a total cost of ownership (TCO) obligation based on the user information. The processor may estimate the TCO obligation for the item based on a plurality of data sources. The plurality of data sources may comprise at least one of Internet information, manufacturer information, a consumer report, and information from social media. A data source may comprise Internet of Things (IoT) device data for a similar item. The processor may then assess an impact on the retirement income growth for the user based on the TCO obligation for the item and/or the user information. The processor may recommend a modification to the investment strategy based on the assessed impact to the retirement income growth. The processor may then determine the impact to the retirement income growth based on the recommended modification to the investment strategy and the TCO obligation for the item. The recommended modification to the investment strategy may be a modification based on a weighted value for a probability of implementation of the modification by the user, a weighted value for an amount of reduction in retirement income growth shortfall caused by the TCO obligation for the item, and a weighted value for a risk tolerance based on the user information.

In one embodiment of the system, the TCO obligation for the item may comprise a net monetary value estimate for the item over a period of time the user maintains control over the item.

Further areas of applicability of the present application will become apparent from the detailed description provided hereinafter. It should be understood that the detailed description and specific examples, while indicating the preferred embodiments of the application, are intended for purposes of illustration only and are not intended to limit the scope of the application.

### BRIEF DESCRIPTION OF THE DRAWINGS

Having thus described some example embodiments in general terms, reference will now be made to the accompanying drawings, which are not necessarily drawn to scale, and wherein:

FIG. 1 depicts an example overall view of the environment in which the system and computer-implemented method of the present application operate to generate of an investment strategy for retirement income growth utilizing the total cost of ownership (TCO) obligation for an item;

FIG. 2 depicts a flowchart diagram describing an exemplary method for generating of an investment strategy for retirement income growth utilizing the TCO obligation for an item;

FIG. 3 depicts a flowchart diagram describing an exemplary method for use in accepting a recommendation to modify an investment strategy and/or a lifestyle interest based on the TCO obligation and a category for an item; and

FIG. 4 is a schematic depiction of a computing device suitable for use with example embodiments of the present application.

### DETAILED DESCRIPTION

The following description of the embodiments of the present application is merely exemplary in nature and is in no way intended to limit the application, its application, or uses. The present application has broad potential application and utility, which is contemplated to be adaptable across a wide range of industries. For example, it is contemplated that financial services companies, insurance companies, and/or other institutions and individuals would have use for the present application. The following description is provided herein solely by way of example for purposes of providing an enabling disclosure but does not limit the scope or substance of the application.

Some example embodiments now will be described more fully hereinafter with reference to the accompanying drawings, in which some, but not all embodiments are shown. Indeed, the examples described and pictured herein should not be construed as being limiting as to the scope, applicability or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used in herein, the terms “component,” “module,” and the like are intended to include a computer-related entity, such as but not limited to hardware, firmware, or a combination of hardware and software. For example, a component or module may be, but is not limited to being, a processor, a process running on a processor, an object, an executable program, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Unless otherwise defined, all terms, including technical and scientific terms, used herein have the same meaning as commonly understood by one of ordinary skill in the art to which this present application belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present application relate to generating an investment plan or strategy for retirement income growth and stabilization utilizing the estimated total cost of ownership (TCO) obligation for an item. With the present application, a user may receive a more informed investment strategy recommendations and/or advice related to retirement income growth that they may not have received or considered otherwise. By having a more accurate estimate for the TCO obligation for an item, an investment strategy for retirement income growth that more closely satisfies the goal for the user may be proposed and implemented.

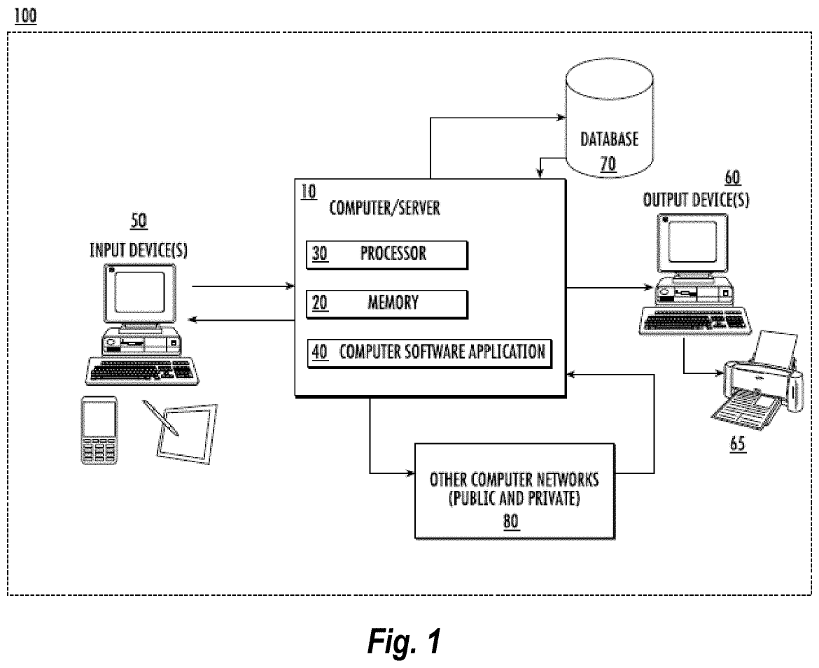

FIG. 1 depicts an example overall view of the environment in which the system and computer-implemented method of the present application operate to generate of an investment strategy for retirement income growth utilizing the total cost of ownership (TCO) obligation for an item. As shown in FIG. 1, the networked computer system 100 of the present application may generally comprise at least one computer or server 10 having memory 20 and a processor 30 for processing data and for executing instructions and programmed computer methods. The networked computer system 100 may include a computer software application 40 comprised of one or more programmed computer software modules executable by the processor 30, an input device 50, for example, a computer, tablet, and/or mobile device for inputting information and data to the computer/server 10, and an output device 60, for example, a computer, tablet, mobile device, and/or a printer 65 for displaying information and data. The computer system 100 may comprise a database 70 for storing information or may be communicatively connected with a database 70 for storing information.

In a preferred aspect of the present application, the computer system 100 is communicatively connected to other computer systems and public and private computer networks 80 such as the internet. The computer networks may have access to public and private data and information. The computer system 100 of the present application may operate in a wireless communication network and with mobile devices, for example, personal data assistants (PDAs), mobile phones, tablets, and other similar devices.

The system and computer-implemented method of the present application may generate an investment strategy pertaining to retirement income for an identified third party or client, referred to herein as a user.

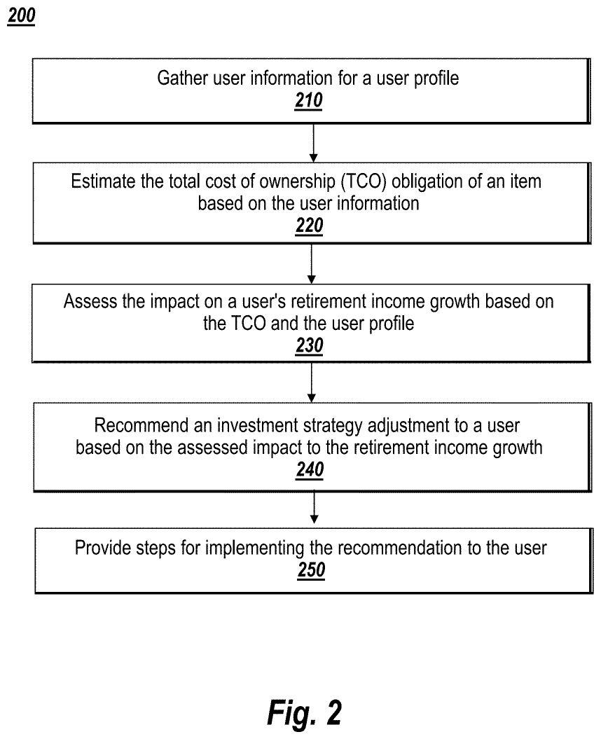

FIG. 2 depicts a flowchart diagram describing an exemplary method for generating of an investment strategy for retirement income growth utilizing the TCO obligation for an item. In accordance with the present application, the method 200 comprises, at step 210, gathering information associated with the user. The gathered user information may be complied and/or referred to as a user profile. The user may input the information directly into a software application being controlled by a processor in a computing device. For example, the processor may provide the user with a series of questions in the form of a questionnaire. The information for the user may also be gathered indirectly, for example, through a financial planner or advisor and/or by the use of third party sources of information.

The processor may gather user information based on a plurality of data sources, for example, from the user, user accounts, the user's employer, private networks, for example, an investment company, and/or public networks, for example, the internet. The user information may comprise personal information for the user, for example, the user's age and/or user life events such as a wedding, family planning, retirement interests, and/or educational interests for the user and/or the user's dependents. The user information may comprise a user goal, for example, a retirement goal, a life goal, an income goal, and/or an asset goal. The user information may comprise financial information, for example bank accounts, investment accounts, retirement accounts, user income, and/or estimated user income potential. The user information may comprise information on the user's financial risk tolerance. The user information may comprise user asset related information, for example information on a business, a property, and/or an asset such as a vehicle. The user information may comprise expense related information, for example, a fixed expense, purchase history data, and/or an anticipated expense. The user information may comprise work related information, for example, information pertaining to the user's career and/or current job. The user information may comprise geographic related information, for example, user travel data, a geographic preference, and/or a preferred retirement location. The user information may comprise user lifestyle information and/or demographic preferences, for example, user preferred entertainment, a social media interest, a hobby, and/or a user's interest. The user information may comprise a user's social media interest, for example, social media commentary, a posting, online activity, and/or research on potential assets to be acquired. Information and data associated with the user is input into the processor and aggregated together to generate a user profile.

At step 220, the processor may estimate the TCO obligation of an item. The processor may determine an item having a TCO obligation based on the user information. For example, the processor may determine an asset owned by the user such as a home, vehicle, an appliance, and/or property. The processor may estimate an anticipated TCO obligation of a future item based on a user's desire to obtain the item, for example, a college education. The TCO obligation for the item may comprise a net monetary value estimate for the item over a period of time the user maintains control over the item.

The processor may base the TCO obligation estimate on a plurality of data sources. For example, the plurality of data sources may comprise internet information, manufacturer information, a consumer report, and/or social media commentary by one or more individuals who have knowledge regarding the item. The internet information may comprise, for example, a report concerning the item, market price for a utility to operate the item, a historical operating cost estimate, and/or additional related information. The manufacturer information may comprise, for example, information on the expected lifetime of the item, a typical operating cost estimate, a typical repair cost for the item, and/or additional related information. The consumer report may comprise, for example, information comparing this item to other items of a similar nature, expected lifetime of the item, a typical operating cost estimate, a performance rating of the item, and/or additional related information. The social media commentary may comprise, for example, user reviews, opinions, suggestions, and/or recommendations related to the item.

The processor may uses online sources and/or Internet of Things (IoT) device data concerning the item to identify and/or estimate potential long term obligation costs that may not be readily apparent to the user and/or a financial advisor when planning for retirement or other goals. For example, the processor may more accurately estimate the actual energy costs for using the item, likely repair costs, related fees, unknown or unanticipated costs by the user which are typically associated with the item, disposal costs, and/or item lifetime of the item and the like using data from IoT appliances currently in existence. Similarly, the processor may estimate the TCO obligation based on user purchase history data. The purchase history data may be obtained, for example, from retailers and service providers, financial institutions, mobile wallet providers, and/or other data sources. The purchase history data may be obtained from actual purchase or ownership records for the item.

The online sources and/or Internet of Things (IoT) device data may comprise information from a smart appliance similar to the item. The device data may include information on energy usage, purchase price, and/or reliability data. The online sources may include ancillary expense information related to and/or associated with the item. For example, when estimating the TCO obligation for medical expenses, an ancillary cost for using the medical facility, such as parking costs and/or mileage to the facility, may be included in the TCO obligation estimate.

The item may be an item that incurs a cost and/or an anticipated cost, for example, an asset, an interest, a consumable, and/or a service. For example, the item may comprise a car, a house, an appliance, a service, and/or a consumable item such as a coffee or gym membership, and the like. The item may be an expected expense, for example, a proposed educational expense, a vacation, and/or an anticipated medical equipment expense based on known or a predicted condition such as family medical history.

At step 230, the processor may assess the impact on a user's retirement income growth based on the TCO and/or the user profile. The processor may extrapolate a resulting retirement income growth and stabilization profile over time based on the estimated TCO obligation for an item. The processor may take user information into account when making the assessment. For example, if the user indicates they rarely drive a vehicle, the processor may estimate a lower TCO obligation for the vehicle than what is typically estimated.

At step 240, the processor may recommend an adjustment in a user's investment strategy for retirement growth over a period of time. For example, the processor may recommend additional savings based on the TCO obligation for an item. The processor may recommend an adjustment in a user's lifestyle interest over a period of time to provide increased retirement income, for example, by recommending to buy a house instead of renting a place, or vice versa, depending on the housing market and location. The processor may recommend the user obtain a different item of similar capabilities with a lower TCO obligation. For example, the processor may recommend the user buy a more reliable appliance with possibly a higher initial cost but with a lower overall TCO obligation. The processor may provide this information to the user in a visual manner, for example, through a graphical format and/or a tabular format.

The processor may recommended the modification to the investment strategy based on a highest ranking modification derived from a cost function utilizing a weighted value for a probability of implementation of the modification by the user, a weighted value for an amount of reduction in retirement income growth shortfall caused by the TCO obligation for the item, and a weighted value for a risk tolerance based on the user information.

At step 250, the processor may provide the user with a plurality of steps for implementing a change in investment strategy to the user based on the user obtaining the item. The plurality of steps for implementing the recommendation may comprise recommending an investment strategy and/or a savings option for the user based on the estimated TCO obligation for an item and the user profile. For example, the processor may recommend the user speak with a financial advisor about alternate retirement income options available to the user.

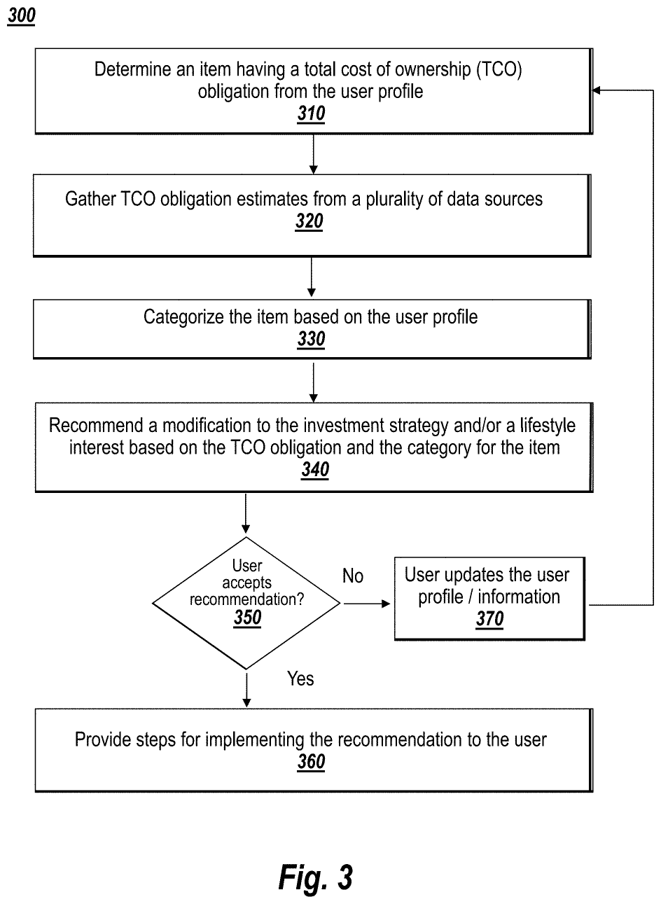

FIG. 3 depicts a flowchart diagram describing an exemplary method 300 a user may use to accept a recommendation to modify an investment strategy, an item, and/or a lifestyle interest based on the TCO obligation and a category for the item.

At step 310, the processor may determine an item with a TCO obligation based on the user information. For example, the processor may determine an asset owned by the user such as a home, vehicle, an appliance, and/or property. The processor may estimate an anticipated TCO obligation of a future item based on a user's desire to obtain the item, for example, a college education. The TCO obligation for the item may comprise a net monetary value estimate for the item over a period of time the user maintains control over the item.

At step 320, the processor may estimate the TCO obligation for the item using a plurality of data sources. For example, the plurality of data sources may comprise internet information, manufacturer information, a consumer report, IoT device data, and/or social media commentary by one or more individuals who have knowledge regarding the item. The estimate TCO obligation may be annualized or amortized and may be used as a basis for calculating, for example, a monthly or yearly retirement savings contribution. As a result, the user may more effectively account for unknown or unanticipated costs by the user in their retirement plans, as opposed to simply allowing for common expense items such as property taxes, up-front vehicle purchase costs, estimated monthly food and utilities, and/or other related expenses. The unknown or unanticipated costs may include costs related to hidden expense patterns that user may not be aware of, for example, probable repair costs, energy costs, reliability data, lifetime estimates, ancillary expenses, and the like.

At step 330, the processor may categorize the item based on the user information. The item may be categorized based on a user need, for example, as being required by the user, such as a place to live, or optional to the user, such as the use of a gym membership. The item may be categorized based on the type of the item, for example, as an asset such a vehicle, an interest such as having children, a consumable such as a product, and/or a service such as obtaining an education.

The TCO obligation for the item may be identified to the user. For example, the TCO obligation may be provided in a total cost, a yearly cost, and/or a per use cost for the item. The TCO obligation may be grouped with a similar type item in a similar category, for example, optional consumable products. The TCO obligation may vary for an item over time based on the user information and/or the category for the item, for example, a user may indicate a desire to travel more in retirement.

At step 340, the processor may recommend a modification to the user's investment strategy, recommend a different or a modified item, and/or a lifestyle interest based on the assessed TCO obligation impact to the retirement income growth and the category of the item. The processor, for example, may recommend a delta cost savings adjustment needed to cover the TCO obligation for an item. The processor may make a recommendation based on the type of item. For example, the processor may recommend the user reduce optional purchases, obtain an item with a lower TCO obligation, and/or switch to a lower cost service provider for an item such as energy, internet, and the like. The processor may make a recommendation based on comparing the TCO obligations for a plurality of similar items. For example, the processor may recommend a vehicle type or make of vehicle to the user based on comparable TCO obligations and user information. The processor may propose a cost saving option to the user. For example, the processor may recommend the user do a service themselves rather than hiring a third party. The processor may recommend different retirement income investment strategies. For example, short term versus long term savings options, income versus growth investments, and the like, based on the user information. The processor may recommend the user move to a location with lower tax rates.

The recommended modification to the investment strategy may be based on a probability of implementation of the modification by the user and/or an amount of reduction in retirement income growth shortfall caused by the TCO obligation for the item. For example, if the user has indicated that relocation is not an option, the processor would not recommend a strategy wherein relocation is proposed. The processor may weigh an investment strategy that meets an expressed goal for the user, for example, an educational expense, more than an investment strategy that meets an implied objective, for example, maximizing retirement savings. The processor may weigh a recommendation that provides more retirement income growth, for example, selling an unused asset, more than an option that provides a lesser amount of retirement income growth, for example, reducing optional consumable purchases.

The processor may provide the user with a recommendation that maximizes a cost function based on a weight for a perceived investment strategy risk associated with a proposed investment strategy, a weight for the probability of implementation of the modification for the investment strategy by the user, a weight for the probability of implementation of the modification to a lifestyle interest by the user, a weight for the probability of implementation of the modification of an item by the user, and/or a weight for an amount of reduction in retirement income growth shortfall caused by the TCO obligation for the item based on the user information. As a result, different investment strategies may be compared against one another based on a variety of criteria, for example, a proposed investment strategy risk, a user risk tolerance, and/or an estimated rate of return for the investment strategy. If, as a result of the investment strategy assessment a gap remains in the retirement income growth shortfall, the processor may provide this information to the user, may recommend that the user meet with a financial advisor and/or may recommend additional adjustments to the user's investment strategy and/or lifestyle interests in order to reduce or eliminate the shortfall in the estimate retirement income.

At step 350, the processor may request that the user either accept or reject the modification to the user's investment strategy, the item, and/or a lifestyle interests.

If the user accepts the recommendation, at step 360, the processor may provide the user with a plurality of steps for implementing the recommendation.

If the user does not accept the recommendation at step 350, the processor may suggest that the user update the user information and/or the user profile.

At step 370, the user may modify the user information and/or the user profile. The user may, for example, change their investment risk tolerance, modify a goal, modify an item, and/or agree to a change in a lifestyle interest. Based on the updated user information, another item having a TCO obligation may be determined. This process may continue until the user receives a recommendation that the user accepts. Once the user accepts the recommendation, the processor may provide the user with a plurality of steps for implementing the recommendation at step 360.

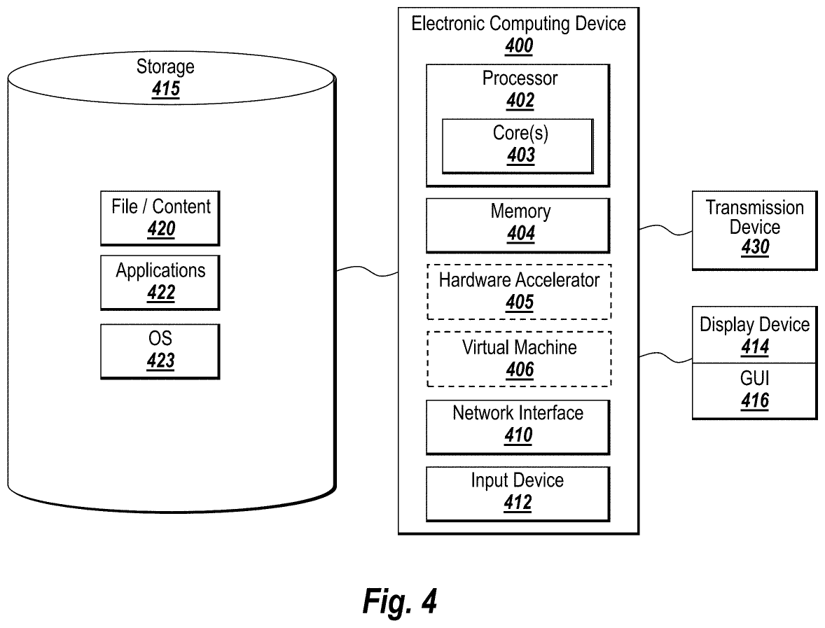

FIG. 4 depicts an example of an electronic device, computing device, and/or processing device 400 suitable for use with one or more embodiments of the present application. The electronic computing device 400 may be located in a networked computer system.

The electronic device 400 may take many forms, including but not limited to a computer, workstation, server, network computer, quantum computer, optical computer, Internet appliance, mobile device, a pager, a tablet computer, a smart sensor, application specific processing device (ASIC), a processing device containing a processor, etc.

The electronic device 400 is illustrative and may take other forms. For example, an alternative implementation of the electronic device 400 may have fewer components, more components, or components that are in a configuration that differs from the configuration of FIG. 4. The components of FIG. 4 and/or other figures described herein may be implemented using hardware based logic, software based logic and/or logic that is a combination of hardware and software based logic (e.g., hybrid logic); therefore, the components illustrated in FIG. 4 and/or other figures are not limited to a specific type of logic.

The processor 402 may include hardware based logic or a combination of hardware based logic and software to execute instructions on behalf of the electronic device 400. The processor 402 may include logic that may interpret, execute, and/or otherwise process information contained in, for example, the memory 404. The processor 402 may be made up of one or more processing cores 403. The information may include computer-executable instructions and/or data that may implement one or more embodiments of the application. The processor 402 may comprise a variety of homogeneous or heterogeneous hardware. The hardware may include, for example, some combination of one or more processors, microprocessors, field programmable gate arrays (FPGAs), application specific instruction set processors (ASICs), application specific integrated circuits (ASICs), complex programmable logic devices (CPLDs), graphics processing units (GPUs), or other types of processing logic that may interpret, execute, manipulate, and/or otherwise process the information. Moreover, the processor 402 may include a system-on-chip (SoC) or system-in-package (SiP). One or more processors 402 may reside in the electronics device 400. An example of a processor 402 is the Intel® Core i3 series of processors available from Intel Corporation, Santa Clara, Calif.

The electronic device 400 may include one or more tangible non-transitory computer-readable storage media for storing one or more computer-executable instructions or software that may implement one or more embodiments of the application. The non-transitory computer-readable storage media may be, for example, the memory 404 or the storage 415. The memory 404 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 400 may include a virtual machine (VM) 406 for executing the instructions loaded in the memory 404. A virtual machine 406 may be provided to handle a process running on multiple processors so that the process may appear to be using only one computing resource rather than multiple computing resources. Virtualization may be employed in the electronic device 400 so that infrastructure and resources in the electronic device may be shared dynamically. Multiple VMs 406 may be resident on a single computing device 400.

A hardware accelerator 405 may be implemented in an ASIC, FPGA, or some other device. The hardware accelerator 405 may be used to reduce the general processing time of the electronic device 400.

The electronic device 400 may include a network interface 410 to interface to a Local Area Network (LAN), Wide Area Network (WAN), Ethernet domain, and/or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 502.11), RF connections, high-speed interconnects (e.g., InfiniBand, gigabit Ethernet, Myrinet) or some combination of any or all of the above. The network interface 410 may include a built-in network adapter, network interface card, personal computer memory card international association (PCMCIA) network card, card bus network adapter, wireless network adapter, universal serial bus (USB) network adapter, modem or any other device suitable for interfacing the electronic device 400 to any type of network capable of communication and performing the operations described herein.

The electronic device 400 may include one or more user input devices 412, for example a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 400 may include other suitable I/O peripherals.

The input devices 412 may allow a user to provide input that is registered on a visual display device 414. A graphical user interface (GUI) 416 may be shown on the display device 414.

A storage device 415 may also be associated with the computer 400. The storage device 415 may be accessible to the processor 402 via an I/O bus. The information in the storage device 415 may be executed, interpreted, manipulated, and/or otherwise processed by the processor 402. The storage device 415 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the application.

The storage device 415 may store any modules, outputs, displays, files, content, and/or information 420 provided in example embodiments. The storage device 415 may store applications 422 for use by the computing device 400 or another electronic device. The applications 422 may include programs, modules, or software components that allow the electronic device 400 to perform tasks. Examples of applications include a questionnaire program to allow a user to input user information, a data mining application to obtain user information for a data source, word processing software, shells, Internet browsers, productivity suites, and programming software. The storage device 415 may store additional applications for providing additional functionality, as well as data for use by the computing device 400 or another device. The data may include files, variables, parameters, images, text, and other forms of data.

The storage device 415 may further store an operating system (OS) 423 for running the computing device 400. Examples of OS 423 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

A transmission device 430 may also be associated with the computer 400. The transmission device 430 may be capable of transmitting and receiving information over radio frequencies using common protocols and/or transmitting and receiving information over Ethernet domains using internet devices. A transmission device 430 may be device comprising a media access controller, for example, an internet PHY device.

One or more embodiments of the application may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the application may be implemented in a programming language. Some examples of languages that may be used include, but are not limited to, Python, C, C++, C#, Java, JavaScript, a hardware description language (HDL), unified modeling language (UML), and Programmable Logic Controller (PLC) languages. Further, one or more embodiments of the application may be implemented in a hardware description language or other language that may allow prescribing computation. One or more embodiments of the application may be stored on or in one or more mediums as object code. Instructions that may implement one or more embodiments of the application may be executed by one or more processors. Portions of the application may be in instructions that execute on one or more hardware components other than a processor.

It is understood that the present application may be implemented in a distributed or networked environment. For example, information may be provided and manipulated at a central server, while a user interacts with the information through a terminal or input/output device.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

It is intended that the present application not be limited to the particular embodiments disclosed above, but that the present application will include any and all particular embodiments and equivalents falling within the scope of the following appended claims.

1. A computer-implemented method for generating an investment strategy related to a retirement income growth for a user, the method comprising:
gathering, by a processor, information about the user from a user profile;
determining, by the processor, a smart appliance having a total cost of ownership (TCO) obligation based on the user information;
estimating, by the processor, the TCO obligation for the smart appliance, the TCO obligation for the smart appliance including a net monetary value estimate for the smart appliance over a period of time the user maintains control over the smart appliance that includes a purchase price of the smart appliance, reliability of the smart appliance, and energy costs of the smart appliance, wherein the estimating includes:
retrieving the energy costs and reliability information from smart appliances having a similar type as the smart appliance;
comparing by the processor the TCO obligations for a plurality of similar smart appliances;
assessing an impact on the retirement income growth for the user based on the TCO obligation for the smart appliance; and
recommending a modification to the investment strategy based on the assessed impact to the retirement income growth.

2. The method according to claim 1, wherein the information about the user comprises at least one of financial information, career information, financial risk tolerance, a lifestyle interest, a demographic value, a user age, a geographic preference, and a social media interest.

3. (canceled)

4. (canceled)

5. (canceled)

6. (canceled)

7. The method according to claim 2, the method further comprising:
categorizing the smart appliance based on the user information.

8. The method according to claim 7, the method farther comprising:
recommending a modification to the lifestyle interest of the user based on the assessed impact to the retirement income growth and the category of the smart appliance.

9. The method according to claim 1, wherein the recommended modification to the investment strategy is based on a probability of implementation of the modification by the user and an amount of reduction in retirement income growth shortfall caused by the estimated TCO obligation for the smart appliance.

10. A system for generating an investment strategy related to retirement income growth for a user, the system comprising:
a processor configured to:
gather information about the user from a user profile;
determine an smart appliance having a total cost of ownership (TCO) obligation based on the user information;
estimate the TCO obligation for the smart appliance, the TCO obligation for the smart appliance including a net monetary value estimate for the smart appliance over a period of time the user maintains control over the smart appliance that includes a purchase price of the smart appliance, reliability of the smart appliance, and energy costs of the smart appliance, wherein to estimate the TCO obligation for the smart appliance, the processor is configured to:
retrieve, from a data source, the energy costs and reliability information from smart appliances having a similar type as the smart appliance;
assess an impact to the retirement income growth for the user based on the TCO obligation for the smart appliance; and
recommend a modification to the investment strategy based on the assessed impact to the retirement income growth.

11. The system according to claim 10, wherein the information about the user comprises at least one of financial information, career information, financial risk tolerance, a lifestyle interest, a demographic value, a user age, a geographic preference, and a social media interest.

12. (canceled)

13. (canceled)

14. (canceled)

15. The system according to claim 11, wherein the processor is furthered configured to:
categorize the smart appliance based on the user information.

16. The system according to claim 15, wherein the processor is furthered configured to:
recommend a modification to the lifestyle interest of the user based on the assessed impact to the retirement income growth and the category of the smart appliance.

17. The system according to claim 10, wherein the recommended modification to the investment strategy is based on a probability of implementation of the modification by the user and an amount of reduction in retirement income growth shortfall caused by the TCO obligation for the smart appliance.

18.-20. (canceled)
